(19) United States
(12) Patent Application Publication
(10) Pub. No.: US 2018/0154334 A1
(43) Pub. Date: Jun. 7, 2018

(54) METHODS FOR REGENERATING A CARBON DIOXIDE CAPTURE ARTICLE

(71) Applicant: Corning Incorporated, Corning, NY (US)

(72) Inventors: William Peter Addiego, Big Flats, NY (US); Paul Oakley Johnson, Corning, NY (US); Sarah Lynn Muccigrosso, Corning, NY (US)

(73) Assignee: Corning Incorporated, Corning, NY (US)

(21) Appl. No.: 15/576,562

(22) PCT Filed: May 17, 2016
(86) PCT No.: PCT/US2016/032861

§ 371 Date: Nov. 22, 2017

Related U.S. Application Data
(60) Provisional application No. 62/166,318, filed on May 26, 2015.

(51) Int. Cl. B01J 20/28; B01J 20/26; B01J 20/34; B01D 53/02; B01D 53/96; C08L 79/02; C08L 1/02; C08L 1/08; C08L 5/04

(52) U.S. Cl. CPC B01J 20/28045; B01J 20/262; B01J 20/2803; B01J 20/28069; B01J 20/28097; B01J 20/3475; B01D 2046/2433; B01D 53/96; C08L 79/02; C08L 1/02; C08L 1/08; C08L 5/04; B01D 53/02

(57) ABSTRACT

Methods for regenerating an article for capturing carbon dioxide (CO₂) from a gas stream include removing a CO₂ capture sorbent from an adsorbent capture honeycomb. Removing the CO₂ capture sorbent from the capture article may include contacting the adsorbent honeycomb and a volume of fluid, wherein the fluid removes the sorbent from the honeycomb, and the honeycomb binder is insoluble in the fluid. Restoring the article may include contacting the honeycomb with a regeneration fluid to deposit a CO₂ capture sorbent on a surface of the honeycomb.

### CROSS REFERENCE TO RELATED APPLICATIONS

This application claims the benefit of priority under 35 U.S.C. § 119 of U.S. Provisional Application Ser. No. 62/166,318 filed on May 26, 2015, the content of which is relied upon and incorporated herein by reference in its entirety.

### BACKGROUND

The present disclosure relates generally to methods for regenerating an article used for capturing carbon dioxide (CO₂) from a gas stream and for removing a CO₂ capture sorbent from an adsorbent honeycomb.

### SUMMARY

According to one embodiment of the present disclosure, a method of removing a CO₂ capture sorbent from an adsorbent honeycomb is disclosed. In embodiments, the honeycomb includes an extruded mixture of a powder, a binder, and the sorbent. The adsorbent honeycomb is contacted with a volume of a polar organic fluid. The polar organic fluid removes the sorbent from the honeycomb. The binder is insoluble in the polar organic fluid.

According to another embodiment of the present disclosure, a method of changing a porosity characteristic of a CO₂ adsorbent honeycomb is disclosed. The honeycomb includes an extruded mixture of a powder, a binder, and the sorbent. The honeycomb is contacted with a volume of a polar organic fluid configured to remove a sorbent from the honeycomb. The binder is insoluble in the polar organic fluid.

According to yet another embodiment of the present disclosure, a method of removing a first CO₂ capture sorbent from a honeycomb and depositing a second CO₂ capture sorbent on or in the honeycomb is disclosed. The honeycomb includes an extruded mixture of a powder, the first CO₂ capture sorbent, and a binder. The honeycomb and a first volume of a polar organic fluid are contacted. The first volume of polar organic fluid removes the first sorbent from the honeycomb. The binder is insoluble in the first volume of polar organic fluid. The honeycomb and the first volume of polar organic fluid are separated. The first volume of polar organic fluid contains an amount of the first CO₂ capture sorbent removed from the contacted honeycomb. The honeycomb and a second volume of polar organic fluid are contacted. The second volume of polar organic fluid includes a second CO₂ capture sorbent. The second CO₂ capture sorbent deposits on a surface of the honeycomb. The binder is insoluble in the second volume of the polar organic fluid.

In yet another embodiment of the present disclosure, a method of regenerating an adsorbent honeycomb is disclosed. The method includes contacting the adsorbent honeycomb with a volume of a polar organic liquid. In embodiments, the honeycomb includes an extruded mixture of a powder, a binder, and a CO₂ capture sorbent. In embodiments, the method includes removing at least a portion of the CO₂ capture sorbent from the honeycomb with the polar organic liquid. In embodiments, the binder is insoluble in the polar organic liquid.

### BRIEF DESCRIPTION OF THE DRAWINGS

The disclosure will be better understood, and features, aspects and advantages other than those set forth above will become apparent when consideration is given to the following detailed description thereof. Such detailed description makes reference to the following drawings, wherein:

FIG. 1 schematically depicts an example CO₂ capture article according to one or more embodiments shown and described herein.

### DETAILED DESCRIPTION

Unless defined otherwise, all technical and scientific terms used herein have the same meaning as commonly understood by one of ordinary skill in the art to which the disclosure belongs. Although any methods and materials similar to or equivalent to those described herein can be used in the practice or testing of the present disclosure, the exemplary methods and materials are described below.

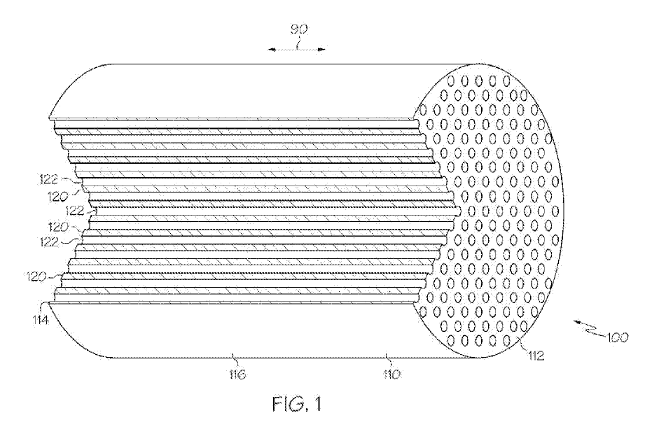

Referring to FIG. 1, a CO₂ capture article 100, alternatively referred to as an adsorbent honeycomb or monolith, is schematically depicted. Article 100 includes a honeycomb 110 having a plurality of partition walls 120 that extend in an axial direction 90 from an inlet end 112 to an outlet end 114. The plurality of partition walls 120 are optionally porous, and form a plurality of flow channels 122 through which a gas stream may flow. Flow channels 122 may include any shape including squares, circles, or any similar quadrilateral. A skin 116 defines the outer diameter of article 100. Alternatively, article 100 comprises a flow-through honeycomb including open channels defined by porous walls. In an alternative embodiment, honeycomb 110 comprises a porous substrate capable of retaining a sorbent. In exemplary embodiments, honeycomb 110 has porosity greater than about 20%. Honeycomb 110 may also have a porosity from about 20% to about 90%, or a porosity from about 30% to about 80%.

In an exemplary embodiment of article 100, honeycomb 110 is formed from a mixture of a powder and a binder that are solidified to make up partition walls 120. In embodiments, honeycomb 110 may also include a liquid vehicle. The liquid vehicle within the support precursor slurry may be water, acetic acid, acetone, toluene, ethyl alcohol, dicholoromethane, octanoic acid, and any other common organic solvents capable of acting as a delivery vehicle for the inorganic particles. Referring to FIG. 1 for example, the powder and the binder form partition walls 120 defining flow channels 122. The mixture may be processed at various temperatures and pressures and may be solidified by extrusion, sintering or other commonly known processes. In one embodiment, honeycomb 110 remains un-sintered, and is bound together by the binder and/or liquid vehicle. The CO₂ sorbent may permeate and/or coat all or a portion of partition walls 120 and surfaces of honeycomb 110.

In another exemplary embodiment of article 100, honeycomb 110 is formed from a mixture of the powder, the liquid vehicle, the binder, and the CO₂ sorbent that are solidified to make up partition walls 120. Referring again to FIG. 1 for example, the powder, the liquid vehicle, the binder, and the CO₂ sorbent form partition walls 120 defining flow channels 122. The CO₂ sorbent may be dispersed throughout and stabilized by the powder that makes up partition walls 120 of honeycomb 110. The mixture may be processed at various temperatures and pressures and may be solidified by extrusion, sintering or other commonly known processes. In one embodiment, honeycomb 110 remains un-sintered, and is instead bound together by the binder, the liquid vehicle, and the CO₂ sorbent dispersed throughout the powder. Various compositions and methods of manufacturing sorbent honeycombs are disclosed in U.S. Publication No. 2013/0207034, the content of which is incorporated by reference herein.

In some embodiments, the powder in article 100 includes, but is not limited to, a high surface area and porous inorganic solid, for example alumina, silica, titania, amorphous and crystalline silicates, or combinations thereof and high surface area carbides such as high surface area silica carbide and other high surface area porous non-oxide inorganic solids. The powder may also include an inorganic oxide. The inorganic oxide may include, for example, non-refractory alumina, non-porous refractory powder, such as alpha alumina or cristobalite, an inorganic molecular silicate, a non-crystalline amorphous silica, a double-layered hydroxide, or combinations thereof. Examples of non-refractory alumina include, but are not limited to, boehmite, α-alumina, γ-alumina, and similar transition alumina phases including amorphous ρ-alumina. Examples of non-crystalline amorphous silica include, but are not limited to, precipitated silica, silica gel, and mesoporous silica. In one embodiment, the inorganic oxide may be a zeolite, including, for example, faujasites, or β-type, X-type, A-type, or MFI-type zeolites. The powder may also include activated carbon either by itself or in combination with one or more inorganic oxides.

The powder in article 100 may be processed prior to the manufacture of honeycomb 110 to provide the desired surface area. In some embodiments, the powder may be milled such that the resulting particle size distribution of the powder promotes poor particle packing, yielding high interstitial and inter-granular porosity that is less than 80% of the powder's theoretical bulk density, for example, less than 50% of the powder's bulk density. For example, the surface area of the powder may be greater than about 50 m²/gram, or greater than about 150 m²/gram. In yet other embodiments, the inorganic powder may be milled such that the surface area is from about 150 m²/gram to about 1000 m²/gram, of from about 150 m²/gram to about 800 m²/gram.

An increase in surface area of the powder may correspond with a decrease in pore size of processed honeycomb 110. Accordingly, high surface area of the powder may prevent the even distribution of the CO₂ sorbent after the powder is processed into a honeycomb. For example, when the pore sizes of the powder are small as compared to the length of the CO₂ sorbent, the CO₂ sorbent group may tend to clog the pores, closing off the pores from a gas stream. Clogged pores reduce the efficacy of the article 100 in capturing CO₂ because the clogged pores prevent access to the CO₂ sorbent within the thickness of the channel walls. As such, the powder incorporated into honeycomb 110 in some embodiments has a mean pore size greater than about 2 nanometers. In some embodiments, the powder may have a mean pore size greater than about 3 nanometers. In yet further embodiments, the powder may have a mean pore size from about 4 nanometers (nm) to about 10 nanometers (nm).

The binder in article 100 may utilize a variety of materials including organic and inorganic binders. Examples of such binders include organic solids such as the cellulosics, methyl cellulose, hydroxyethyl cellulose and other cellulosics, Arabic gum, alginates, polymer binders such as vinyl acetate, acrylates, acrylic and vinyl latexes, thermoset polymers, such as phenolic resins, various monomers that could be polymerized in situ, polymers that can be cross-linked in situ, as well as silicones, alkoxides, and various clays, and other inorganic salts and materials, such as aluminum oxyhydroxide (boehmite), sodium silicate, and the like, as conventionally known.

The binder in article 100 maintains the powder in a pre-determined shape, even in the absence of the CO₂ sorbent. In one embodiment, the binder is an organic compound that is a dispersible or soluble solid that has strength properties sufficient to maintain the shape of honeycomb 110 for low-stress, low-temperature applications, such that sintering of honeycomb 110 is unnecessary. The use of an unsintered powder component to form honeycomb 110 results in a honeycomb substrate having a high surface area and porosity as compared with the overall dimensions of honeycomb 110. The organic binder, such as cellulosics, polyethylene glycols and polyethylene oxides, polyvinyl compounds, polyvinyl pyrrolidones, and other polymers, also provides rheological performance to promote and maintain the substrate structure upon forming. The binder typically remains in honeycomb 110 after extrusion and subsequent processing. In some embodiments, the binder includes a material that sorbs CO₂.

The CO₂ sorbent of article 100 may include, but is not limited to, amine polymers, for example, polyethyleneimine (PEI), polyamidoamine (PAMAM), and polyvinyl amine. Examples of such compounds also include tetraethylenepentamine, diethanolamine, diethylenetriamine, pentaethylenehexamine, as well as alkyaminoalkoxysilanes such as dimethylaminopropyltrimethoxysilane, among others. CO₂ sorbents in some embodiments may include the use of any and all nitrogenous-bearing organic compounds capable of absorbing CO₂ as a carbonate or carbamate or other species. The CO₂ sorbent in other embodiments, for example polyethyleneimine, may have a molecular weight from about 600 Daltons to about 10,000 Daltons.

According to an exemplary embodiment, to adsorb CO₂, the CO₂ sorbent may be dispersed throughout the powder of honeycomb 110 such that the CO₂ sorbent is located in and on partition walls 120. The phrase “in the partition walls” as used herein, means the CO₂ sorbent is located around and in the pores of discrete particles of the powder. The CO₂ sorbent, in the case of a polymer or monomer, may be cross-linked both in and on partition walls 120 using a cross-linking agent and/or a polymerizing agent included in the mixture.

Article 100 described above may be used in various processes to capture CO₂. In an example CO₂ capture process, referring again to FIG. 1, a gas stream containing CO₂ flows into the inlet end 112 of article 100 and is directed through flow channels 122. The sorbent reacts with the CO₂ in the gas stream and forms a coordinated bond with the CO₂, which creates carbonate, bicarbonate, carbamates, or other coordinated or ionic compounds, thereby adsorbing the CO₂ from the gas stream.

In some CO₂ capture processes, article 100 may have insufficient porosity so as to effectively contact and adsorb the desired quantity of CO₂ from a carrier gas stream. That is, article 100 is sufficiently impenetrable that a gas stream containing CO₂ cannot access the article's channels and/or pores and contact the CO₂ sorbent. This may be caused by contaminates, fouling from the CO₂ carrier gas, or overloading article 100 with CO₂ sorbent during manufacturing. Accordingly, it might be desired that article 100 have additional porosity or an altered disposition of the sorbent within the pores to more effectively contact and adsorb the desired quantity of CO₂ from a gas stream. In other CO₂ capture processes, the pressure drop across article 100 may be too high for a particular operation. Accordingly, the disclosure below provides methods of changing a porosity characteristic of CO₂ capture articles.

In an example CO₂ capture process, desorption of the captured CO₂ is desired. Various processes and methods exist to release CO₂ from CO₂ capture articles. In another example CO₂ capture process, the CO₂ sorbent is part of an ongoing cyclical process to repeatedly adsorb and desorb CO₂ from a gas stream. However, for a number of reasons, over repeated adsorption cycles, the CO₂ sorbent may degrade and/or lose capacity to adsorb CO₂. Accordingly, the disclosure below provides methods for regenerating the CO₂ sorbent.

In the present method for regenerating a CO₂ capture article, honeycomb 110 contacts a fluid to remove the CO₂ sorbent. In embodiments, the method may include contacting honeycomb 110 with a volume of a polar organic fluid. In another embodiment, the method may include removing at least a portion of the CO₂ capture sorbent from honeycomb 110 with the polar organic fluid. The fluid may be a gas or a liquid capable of removing the CO₂ sorbent from honeycomb 110. In an exemplary embodiment, the fluid will selectively dissolve or bond to the CO₂ sorbent. Accordingly, the fluid removes all or portion of the CO₂ sorbent from honeycomb 110. For example, depending on contact time and the solubility of the CO₂ sorbent in the fluid, the fluid removes 1%, 5%, 10%, 20%, 30%, 40%, 50%, 60%, 70%, 80%, 90%, or up to 100% of the CO₂ sorbent from honeycomb 110. In example embodiments the fluid removes from about 10% to about 100% of the CO₂ sorbent from honeycomb 110, or from about 20% to about 100%, or even from about 20% to about 90%.

Contacting honeycomb 110 with the fluid includes immersing or soaking honeycomb 110 in the fluid, or alternatively, rinsing, washing, or flowing the fluid over honeycomb 110. In exemplary methods, contacting honeycomb 110 with the fluid includes bath immersion, recirculated washing (with or without vacuum), channel flushing, and similar methods to maximize contact between the fluid and honeycomb 110 and thereby improve CO₂ sorbent removal efficacy. Depending on whether the fluid is a liquid or gas, CO₂ sorbent removal from honeycomb 110 can be described as leaching, extraction, or stripping.

According to an exemplary embodiment, the fluid of the present method may include a liquid or gas capable of removing the CO₂ sorbent from honeycomb 110. In one embodiment, the fluid is a polar organic liquid that is capable of removing a particular CO₂ sorbent from honeycomb 110 of the present disclosure. In another embodiment, the fluid has a viscosity less than 300 centipoise (cP) to allow the fluid to penetrate the structure of honeycomb 110 and wet the internal and external surfaces of honeycomb 110. In embodiments, the viscosity may be greater than 0.5 centipoise (cP). Specifically, the fluid may penetrate the pores of honeycomb 110 to remove CO₂ sorbent trapped therein. In alternative embodiments, the fluid contains a surfactant to lower the surface tension of the fluid. In embodiments, the surface tension of the fluid may be from about 0.5 dynes/cm to about 25 dynes/cm (at 25° C.), or even from about 20 dynes/cm to about 25 dynes/cm (at 25° C.).

In one embodiment, the fluid is an alcohol such as methanol, isopropyl alcohol, ethanol, propanol, butanol, and other similar simple alcohols which are capable of dissolving or chemically bonding to a particular CO₂ sorbent of the present disclosure. In other embodiments, the liquid may be a glycol ether, a polyether, a ketone, an ester, an alcohol, or mixtures thereof sufficient to dissolve a particular CO₂ sorbent of the present disclosure. In yet another embodiment, the fluid may be super-critical CO₂. In yet another embodiment, the fluid is a polar solvent capable of removing a poly amine sorbent without altering the article structure retained by the powder and the binder. In exemplary embodiments, the fluid will not dissolve the powder and/or the binder in honeycomb 110. That is, the fluid is chosen to selectively dissolve the CO₂ sorbent from honeycomb 110, but not the powder or binder. In another embodiment, the fluid can be a liquid or a gas.

The fluid volume contacting honeycomb 110 may be from about 0.1 to about 15 times larger than the total volume of honeycomb 110, or from about 2 to about 20 times the total volume of honeycomb 110. In an exemplary embodiment, the fluid volume may be about 5 to about 10 times the total volume of honeycomb 110. Increasing the volume of the fluid contacting honeycomb 110 will increase the CO₂ sorbent removal efficacy. When contacting honeycomb 110, the fluid may be at a temperature from about 20° C. to about 26° C. Honeycomb 110 may also be at a temperature from about 20° C. to about 26° C. when contacting the fluid. The contacting temperatures of the fluid and honeycomb 110 may be optimized so as to increase the CO₂ sorbent removal rate. In one embodiment, the fluid contacting temperature is less than a temperature where the binder is soluble in the fluid. The contacting temperature may also be below a temperature that would compromise the structure of honeycomb 110.

In the present method, honeycomb 110 and the fluid are contacted for a time to achieve a desired removal of CO₂ sorbent. The contact time can be 2 minutes or less, 5 minutes or less, or 10 minutes or less, for example, up to 60 minutes or less when the fluid concentration and/or contact temperature is low (e.g., about 20-25° C.). In one embodiment, the contact time is such that about 70% or more of the total adsorption capacity of article 100 is exposed to the fluid so as to saturate the chemically and physically available sites. Contacting honeycomb 110 with the fluid will remove at least a portion of the CO₂ capture sorbent from honeycomb 110. Contacting honeycomb 110 with the fluid will also change a porosity characteristic of honeycomb 110, such as the overall porosity, mean pore size, and/or total pore volume. For example, contacted honeycomb 110 has a porosity increase of about 20% to about 50%, and even up to about 100%, following contact with the fluid. Contacted honeycomb 110 also has a mean pore size decrease of about 10% to about 75% following contact with the fluid. Contacted honeycomb 110 further has a total pore volume increase of about 100% to about 120% following contact with the fluid. Further, contacted honeycomb 110 has a total surface area increase of about 50% to about 150% following contact with the fluid.

After honeycomb 110 and the fluid are contacted according to the present method, honeycomb 110 and the fluid are separated. This involves removing honeycomb 110 from the fluid or removing the fluid from surrounding honeycomb 110. In exemplary embodiments, the removed fluid will contain an amount of the CO₂ sorbent removed from honeycomb 110. The amount of the CO₂ sorbent contained in the removed fluid will depend on the contact time, the contact temperature, and the solubility of the CO₂ sorbent in the fluid. For example, the fluid contains 1%, 5%, 10%, 20%, 30%, 40%, 50%, 60%, 70%, 80%, 90%, or up to 100% of the CO2 sorbent from contacted honeycomb 110.

In one embodiment of the present method, following separation of honeycomb 110 and the fluid, honeycomb 110 may be rinsed with a second volume of the fluid or another similar gas or liquid to remove residual fluid or CO₂ sorbent from honeycomb 110. In another embodiment, honeycomb 110 is dried at a room temperature between about 16° C. and about 26° C. Alternatively, honeycomb 110 is thermally heated to dry at a temperature between about 30° C. to about 60° C. to remove residuals of the fluid or CO₂ sorbent from honeycomb 110.

In another embodiment of the present method, the CO₂ sorbent is removed from honeycomb 110 and another CO₂ sorbent is deposited on honeycomb 110. In one step of this method, honeycomb 110 and a first fluid are contacted to remove the CO₂ sorbent from honeycomb 110. In another step, honeycomb 110 and the first fluid may be separated. In another step, a regeneration fluid may be prepared containing a mixture of CO₂ sorbent and a solvent. In a further step, contacted honeycomb 110 and a regeneration fluid may be contacted to deposit CO₂ sorbent on the surface of contacted honeycomb 110. In yet another step, twice contacted honeycomb 110 and the regeneration fluid may be separated.

CO₂ sorbent contained within the regeneration fluid may be previously unused CO₂ sorbent or CO₂ sorbent recycled from a previous CO₂ sorbent removal method as described above. The solvent of the regeneration fluid may be a liquid or a gas. Alternatively, the solvent is the same chemical compound as the fluid used to remove CO₂ sorbent from honeycomb 110 as described in the methods above. In exemplary embodiments of the present method, the solvent is a chemical compound capable of dissolving or reducing the viscosity of the CO₂ sorbent contained in the regeneration fluid. In exemplary embodiments, the solvent will not dissolve the powder and/or the binder in honeycomb 110. That is, the solvent is chosen to selectively dissolve or reduce the viscosity of the CO₂ sorbent. In another embodiment, the regeneration fluid contains surfactants and/or dispersants to assist with depositing the CO₂ sorbent on honeycomb 110.

In embodiments of the present method, the removed CO₂ sorbent and the subsequently deposited CO₂ sorbent are the same or a different chemical compound. Alternatively, the subsequently deposited CO₂ sorbent is the same material as the removed CO₂ sorbent. That is, the removed CO₂ sorbent is immediately re-deposited on honeycomb 110 or treated, regenerated, or reactivated and then re-deposited on honeycomb 110.

Contacting the previously contacted honeycomb 110 with the regeneration fluid includes immersing or soaking honeycomb 110 in the regeneration fluid, or alternatively, rinsing, washing, or flowing the regeneration fluid over honeycomb 110. In exemplary methods, contacting honeycomb 110 with the regeneration fluid includes bath immersion, recirculated impregnation (with or without vacuum), and similar methods to maximize contact between the regeneration fluid and honeycomb 110 and thereby improve the amount of CO₂ sorbent deposited on contacted honeycomb 110.

### EXAMPLES

The methods of the present disclosure for regenerating a CO₂ capture article will be further clarified with reference to the following examples.

### Example 1

A honeycomb was prepared by mixing a batch including 65 wt. % silica gel, 32 wt. % liquid PEI, 6 wt. % hydroxypropyl methyl cellulose, and 1 wt. % Durasyn 162. The batch was plasticized and extruded into a honeycomb structure having about 400 flow channels per square inch defined by partition walls having a thickness of about 0.18 millimeters (0.007 inches). The honeycomb was dried for several days at about 40° C. High-Performance Liquid Chromatography (HPLC) analysis determined that the dried honeycomb contained about 30 wt. % PEI.

The honeycomb was then evaluated using the (i) Branauner-Emmett-Teller (BET) Surface Area Analysis; (ii) the Barrett-Joyner-Halenda (BJH) Pore Size and Volume Analysis; and (iii) Mercury Intrusion Porosimetry (MIP) and Image Analysis. The honeycomb with PEI evaluation results are provided in Table 1 below.

TABLE 1
Honeycomb's Characteristics with PEI

| | BET | BJH Analysis | | MIP Analysis | | |
|---|---|---|---|---|---|---|
| | Analysis | | Median | | | Median |
| | Surface | Pore | Pore | Total | Pore | Pore |
| | Area | Volume | Size | Porosity | Volume | Size |
| | (m²/g) | (cm³/gram) | (Å) | (%) | (cm³/gram) | (μm) |
| Honeycomb | 73 | 0.28 | 97 | 40 | 0.39 | 0.044 |
| with PEI | | | | | | |

Subsequently, the honeycomb was immersed in a pure methanol bath for about 10 minutes to remove the PEI. The ratio of the methanol volume to the honeycomb total volume was about 10:1. The honeycomb was removed from the bath, rinsed with fresh methanol, and dried for 10 minutes at 30° C.-60° C. The honeycomb was again immersed in a fresh, pure methanol bath, rinsed with methanol, and dried as described above 3 times. Upon physical inspection, the methanol did not weaken the structural integrity of the composite honeycomb. HPLC Analysis determined that the dried, methanol washed honeycomb contained about 12 wt. % PEI.

The honeycomb with PEI removed was then evaluated using the (i) BET Analysis; (ii) BJH Analysis; and (iii) and MIP Analysis. The honeycomb after PEI removal evaluation results are provided in Table 2 below.

TABLE 2
Honeycomb's Characteristics after PEI Removal by Methanol

| | BET | BJH Analysis | | MIP Analysis | | |
|---|---|---|---|---|---|---|
| | Analysis | | Median | | | Median |
| | Surface | Pore | Pore | Total | Pore | Pore |
| | Area | Volume | Size | Porosity | Volume | Size |
| | (m²/g) | (cm³/gram) | (Å) | (%) | (cm³/gram) | (μm) |
| Honeycomb | 187 | 0.57 | 86 | 60 | 0.86 | 0.011 |
| with PEI | | | | | | |
| removed | | | | | | |

The evaluation results in Tables 1 and 2 provide a comparison of a honeycomb's characteristics before and after PEI removal by methanol. When PEI was removed, the surface area of the honeycomb increased by about 156%. Also, the total porosity of the honeycomb increased by 50%. Further, the pore volume of the honeycomb increased by about 100% to about 120% as determined by BJH Analysis and MIP Analysis, respectively. The median pore size decreased by about 75% as the methanol removed PEI from smaller pores in the partition walls of the honeycomb.

### Example 2

A 15 cm long honeycomb (different than the honeycomb used in Example 1) was prepared by mixing a batch including 65 wt. % silica gel, 32 wt. % liquid PEI, 6 wt. % hydroxypropyl methyl cellulose, and 1 wt. % Durasyn 162. The batch was plasticized and extruded into a honeycomb structure having about 400 flow channels per square inch defined by partition walls having a thickness of about 0.18 millimeters (0.007 inches). The honeycomb was dried for several days at about 40° C. The dried honeycomb weighed 24.34 grams.

The honeycomb was immersed in a methanol bath for about 10 minutes to remove the PEI. The ratio of the methanol volume to the honeycomb total volume was about 10:1. The honeycomb was removed from the bath, dried for 15 minutes at 30° C.-60° C., and then weighed. Three additional times, the honeycomb was immersed in a fresh methanol bath, dried, and weighed. The weight of the honeycomb after each methanol immersion and subsequent drying is provided in Table 3 below.

TABLE 3
Honeycomb's Mass Following Successive Methanol Washes

| Methanol Wash and Dry # | Mass (g) of the dried honeycomb |
|---|---|
| 0 | 24.34 |
| 1 | 23.53 |
| 2 | 20.48 |
| 3 | 21.16 |
| 4 | 19.09 |

The evaluation results in Table 3 provide that the mass of the honeycomb decreases by about 22 wt. %, corresponding to the removal of PEI, after the fourth methanol wash and dry.

PEI with a molecular weight of about 600-800 grams/mol was diluted in a methanol solution to create a 97 mL mixture with a volumetric ratio of about 5:1 methanol to PEI. The honeycomb after methanol wash 4 from above was half-immersed in the methanol/PEI mixture for 5 minutes and then inverted to immerse the other half for 5 minutes in the mixture. Subsequently, the honeycomb was dried and weighed. Two additional times, the honeycomb was half-immersed and inverted to immerse the other half in a fresh methanol/PEI mixture, dried, and weighed. The weight of the honeycomb after each methanol/PEI mixture immersed and subsequent drying is provided in Table 4 below.

TABLE 4
Honeycomb's Mass Following Successive
Methanol/PEI Mixture Washes

| Methanol/PEI | Mass (g) of the dried | Drying Conditions (at |
|---|---|---|
| Mixture Wash and Dry # | honeycomb | 30° C. in oven) |
| 0 | 19.10 | N/A |
| 1 | 23.20 | 30 minutes |
| 2 | 27.62 | about 18 hours |
| 3 | 30.61 | about 48 hours |

The evaluation results in Table 4 provide that the mass of the honeycomb increased by about 60 wt. %, corresponding to the uptake of PEI, after the third methanol/PEI mixture wash and dry. Unexpectedly, the PEI contained on the honeycomb after three methanol/PEI mixture washes is greater than the PEI amount contained in the original honeycomb by about 85%.

### Example 3 (Prophetic)

A honeycomb similar to that provided in Example 1, but devoid of PEI, is prepared.

A mixture of ethanol and tetraethoxysilane (TEOS) is prepared such that the amount of TEOS in the mixture is about 30 wt. % silicon dioxide (SiO₂). The honeycomb (free of PEI) is immersed in the alcohol/TEOS mixture for 5-10 minutes to infuse the honeycomb with TEOS. Subsequently, the honeycomb is removed from the mixture. Excess alcohol/TEOS mixture entrained in the honeycomb is removed with an air knife. The part is dried for 10 minutes at 26° C. and then for 10 minutes at 70° C. in an oven. The honeycomb is then calcined at about 400° C.-600° C. for about 2-4 hours to thermally degrade and remove the hydroxypropyl methyl cellulose from the honeycomb structure. During calcination, the TEOS is converted to SiO₂ in and on the honeycomb to ensure the honeycomb's structural integrity without the presence of hydroxypropyl methyl cellulose.

PEI with a molecular weight of about 600-800 grams/mol is diluted in a methanol solution to create a mixture with a volumetric ratio from about 1:1 to about 5:1 methanol to PEI. Following calcination, the honeycomb is immersed in the methanol/PEI mixture for about 5-10 minutes. PEI uptake in and on the honeycomb is expected similar to that provided in Table 4. Subsequently, the honeycomb is dried at about 30° C.-60° C. for about 2-4 hours.

### Example 4 (Prophetic)

A honeycomb is prepared similar to that as provided in Example 1.

The honeycomb is used in a CO₂ capture process until the PEI is degraded via oxidation. Subsequently, the honeycomb is calcined at about 400° C.-600° C. for about 2 hours to completely oxidize the PEI and remove the PEI from the honeycomb structure.

PEI with a molecular weight of about 600-800 grams/mol is diluted in a methanol solution to create a mixture with a volumetric ratio from about 1:1 to about 5:1 methanol to PEI. Following calcination, the honeycomb is immersed in the methanol/PEI mixture for 5-10 minutes to infuse the honeycomb with PEI. Subsequently, the honeycomb was dried at about 30° C.-60° C. for several days. PEI uptake in and on the honeycomb is expected similar to that provided in Table 4.

### Example 5 (Prophetic)

A honeycomb is prepared similar to that as provided in Example 1.

The honeycomb is used in a CO₂ capture process until the PEI is degraded via oxidation. Subsequently, the honeycomb is placed in a PEI regeneration plug-flow type reactor. The reactor includes a structure capable of encapsulating the honeycomb. The reactor includes an inlet and outlet at opposite ends of the reactor to flow fluid through the reactor. Methanol is flowed through the reactor to contact the honeycomb and leach the PEI from the honeycomb. The volume of methanol flowed through the reactor would be from about 2-20 times the volume of the bulk honeycomb. Flow rate is adjusted to achieve results similar to Table 3 in about 40 minutes or less.

As used in this specification and the appended claims, the singular forms “a”, “an”, and “the” encompass embodiments having plural referent, unless the content clearly dictates otherwise.

Also herein, all numbers are assumed to be modified by the term “about” and preferably by the term “exactly.” Notwithstanding that the numerical ranges and parameters setting forth the broad scope of the invention are approximations, the numerical values set forth in the specific examples are reported as precisely as possible. All numerical values, however, inherently contain certain variability necessarily resulting from the standard deviation found in their respective testing measurements. Absent an understanding by one of ordinary skill in the art to the contrary, numbers modified by the term “about” herein means±5%.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

1. A method of removing a sorbent from an adsorbent honeycomb, the method comprising:
contacting the adsorbent honeycomb with a volume of a polar organic fluid,
wherein the honeycomb includes an extruded mixture of a powder, a binder, and a CO2 capture sorbent,
wherein the polar organic fluid removes the CO2 capture sorbent from the honeycomb, and
wherein the binder is insoluble in the polar organic fluid.

2. The method of claim 1, wherein the polar organic fluid is a liquid with a viscosity less than about 300 centipoise.

3. The method of claim 1, wherein the polar organic liquid is selected from the group consisting essentially of a glycol ether, a polyether, a ketone, an ester, an alcohol, or a mixture thereof.

4. The method of claim 1, wherein the volume of the polar organic fluid is from about 5 to about 10 times a total volume of the honeycomb.

5. The method of claim 1, wherein the sorbent comprises an amine polymer.

6. The method of claim 5, wherein the amine polymer is selected from the group consisting of polyethyleneimine, polyamidoamine, and polyvinylamine.

7. The method of claim 1, wherein the binder comprises a solid organic compound.

8. The method of claim 7, wherein the solid organic compound is selected from the group consisting essentially of cellulosics, methyl cellulose, hydroxyethyl cellulose, hydroxypropyl methyl cellulose, Arabic gum, alginate, and a mixture thereof.

9. The method of claim 1, wherein the polar organic fluid is at a temperature from about 20° C. to about 26° C. when contacting the honeycomb.

10. The method of claim 1, wherein when contacting the honeycomb and the polar organic fluid, a contacting temperature is less than a temperature where the binder is soluble in the polar organic fluid.

11. The method of claim 1, wherein the honeycomb has a porosity from about 20% to about 90%.

12. The method of claim 1, further comprising separating the honeycomb and the polar organic fluid, the polar organic fluid contains an amount of the sorbent removed from the contacted honeycomb.

13. The method of claim 1, further comprising rinsing the contacted honeycomb with a second volume of the polar organic fluid.

14. The method of claim 1, further comprising heating the contacted honeycomb between about 30° C. to about 60° C. to remove residuals of the polar organic fluid in the rinsed honeycomb.

15. A method of changing a porosity characteristic of a CO2 adsorbent honeycomb, the method comprising:
contacting the honeycomb with a volume of a polar organic fluid configured to remove a sorbent from the honeycomb,
wherein the honeycomb includes an extruded mixture of a powder, a binder, and a sorbent,
wherein the polar organic fluid removes the sorbent from a pore of the honeycomb, and
wherein the binder is insoluble in the polar organic fluid.

16. The method of claim 15, wherein the contacted honeycomb has a porosity increase from the honeycomb of about 20% to about 50%.

17. The method of claim 15, wherein the contacted honeycomb has a mean pore size decrease from the honeycomb of about 10% to about 75%.

18. The method of claim 15, wherein the contacted honeycomb has a total pore volume increase from the honeycomb of about 100% to about 120%.

19. A method of removing a first CO2 capture sorbent from a honeycomb and depositing a second CO2 capture sorbent on or in the honeycomb, the method comprising:
contacting the honeycomb and a first volume of a polar organic fluid,
wherein the honeycomb includes an extruded mixture of a powder, the first CO2 capture sorbent, and a binder,
wherein the first volume of polar organic fluid removes the first sorbent from the honeycomb, and the binder is insoluble in the first volume of polar organic fluid;
separating the honeycomb and the first volume of polar organic fluid,
wherein the first volume of polar organic fluid contains an amount of the first CO2 capture sorbent removed from the contacted honeycomb; and
contacting the honeycomb and a second volume of a polar organic fluid,
wherein the second volume of polar organic fluid includes a second CO2 capture sorbent,
wherein the binder is insoluble in the second volume of polar organic fluid, and
wherein the second sorbent deposits on a surface of the honeycomb.

20. The method of claim 19, wherein the first sorbent has the same chemical composition as the second sorbent.

21-25. (canceled)
